(19) United States
(12) Patent Application Publication
(10) Pub. No.: US 2004/0021282 A1
(43) Pub. Date: Feb. 5, 2004

(54) Miniature skateboard/skate

(76) Inventor: Ron A. Grattini, Chatsworth, CA (US)

Correspondence Address: ELLSWORTH R. ROSTON, FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/210,590

(22) Filed: Jul. 31, 2002

(51) Int. Cl. B62M 1/00; A63C 17/00

(52) U.S. Cl. 280/87.042; 280/11.19

(57) ABSTRACT

A miniature skateboard includes a platform preferably of a size less than that of a user's shoe. Axles are attached to the undersurface of the platform at longitudinally spaced positions. Wheels are attached to the axles at laterally spaced positions. A support member coupled to a pivot pin on the platform near the platform rear end is manually pivotable between first and second positions. In the first position, the support member is disposed under the platform. In the second position, the support member extends rearwardly from the platform to support the user's other foot. A clip on the platform retains the skateboard on the user's belt when the skateboard is not being used. Straps laterally disposed on the platform near the platform front end convert the skateboard to a skate when the straps are tightly coupled and the clip is pivoted to a position displaced from the platform.

This invention relates to a miniature skateboard constructed to provide for a disposition of one or both of a user's feet on the skateboard. The invention also relates to a miniature skateboard which is easily convertible to a skate.

### BACKGROUND OF THE PREFERRED EMBODIMENTS OF THE INVENTION

Skateboards have been popular for use by pre-teenagers and teenagers for decades. The skateboard has generally included a platform on which the user has disposed one of his feet when he is pedaling with the other foot and on which the user has disposed both of his feet when he is coasting or when he is performing stunts on the skateboard.

The skateboard is relatively large and bulky. For example, the platform on the skateboard may have a length of approximately eighteen inches (18″) and may have a width of approximately six inches (6″). This has caused the skateboard to be relatively heavy and cumbersome. The size and weight of the skateboard, furthermore, have reduced the challenge to the skateboard user in operating the skateboard and in performing stunts on the skateboard. This is particularly true when the user is skilled in operating the skateboard and in performing stunts on the skateboard.

In co-pending application ______ (attorney docket SPFUN-61140) assigned of record to the assignee of record of this application, a miniature skateboard is disclosed and claimed to resolve the problems discussed in the previous paragraph. The miniature skateboard includes a platform having a size preferably less than that of a user's shoe. For example, the miniature skateboard may have a length approximating six inches (6″) and a width approximating two inches (2″). Axles are attached to the undersurface of the platform at longitudinally spaced positions. Wheels are attached to the axles at laterally spaced positions.

A support member in the miniature skateboard disclosed and claimed in co-pending application ______ (attorney docket SPFUN-61140) is coupled to a pivot pin near the platform rear end and is manually pivotable between first and second positions. In the first position, the support member is disposed under the platform. In the second position, the support member extends rearwardly from the platform to support the user's other foot. A clip fixedly disposed on the platform retains the skateboard on the user's clothing (e.g., pants belt) when the skateboard is not being used.

### BRIEF DESCRIPTION OF A PREFERRED EMBODIMENT OF THE INVENTION

A miniature skateboard includes a platform having a size preferably less than that of a user's shoe. For example, the miniature skateboard may have a length approximating six inches (6″) and a width approximating two inches (2″). One foot of the user is disposed on the platform when the user is operating the skateboard. Axles are attached to the undersurface of the platform at longitudinally spaced positions. Wheels are attached to the axles at laterally spaced positions.

A support member coupled to a pivot pin near the platform rear end is manually pivotable between first and second positions. In the first position, the support member is disposed under the platform. In the second position, the support member extends rearwardly from the platform to support the user's other foot when the skateboard is coasting or when the user is performing stunts on the skateboard.

A clip disposed on the platform and having a first pivotable position retains the skateboard on the user's clothing (e.g., pants belt) when the skateboard is not being used. The clip is pivotable to a position (a) providing a backstop for the user's foot when the user is operating the skateboard, and (b) supporting the skateboard in a tilted relationship when the user is not using the skateboard and the clip is disposed on a support surface with the clip at approximately a 90° relationship with the platform. Straps laterally disposed near the platform front end convert the skateboard to a skate when the straps are coupled to each other as by Velcro and when the clip is pivoted to the approximately 90° relationship to the platform.

### BRIEF DESCRIPTION OF THE DRAWINGS

In the Drawings:

FIG. 1 is a schematic perspective view of a prior art miniature skateboard coupled to a pants belt of a user to facilitate the transport of the skateboard by the user when the user is not operating the skateboard, features of the prior art miniature skateboard being incorporated in a miniature skateboard constituting a preferred embodiment of this invention;

FIG. 2 is an enlarged top plan view of the prior art miniature skateboard shown in FIG. 1;

FIG. 3 is an enlarged top plan view of the prior art miniature skateboard and shows a support member forming a part of the miniature skateboard and pivotable to a position relative to a platform on the skateboard to provide for a disposition of one of the user's feet on the platform and the other of the user's feet on the support member;

FIG. 4 is a front elevational view of the prior art skateboard and shows the support member in an extended position relative to the platform to provide a support for the user's feet on the platform and the support member;

FIG. 5 is an enlarged fragmentary perspective view showing the disposition of one of the user's feet on the platform and the sole of the other of the user's feet on the support member;

FIG. 6 is an enlarged fragmentary side elevational view of the miniature skateboard and shows a clip disposed at the rear end of the platform and pivotable to a position displaced from the platform for providing a disposition of the skateboard on a support surface with the clip pivotably displaced from the platform;

FIG. 7 is an enlarged top plan view of the miniature skateboard shown in FIG. 6 and shows the inclusion of straps which are disposed at the front end of the platform and which cooperate with the clip to define a skate when the clip is displaced from the platform by an angle of approximately 90° and when the straps are coupled to each other as by Velcro; and

FIG. 8 is an enlarged front elevational view of the miniature skateboard when the straps and the clip are disposed as in FIG. 7 to convert the apparatus from a skateboard to a skate.

### DETAILED DESCRIPTION OF A PREFERRED EMBODIMENT OF THE INVENTION

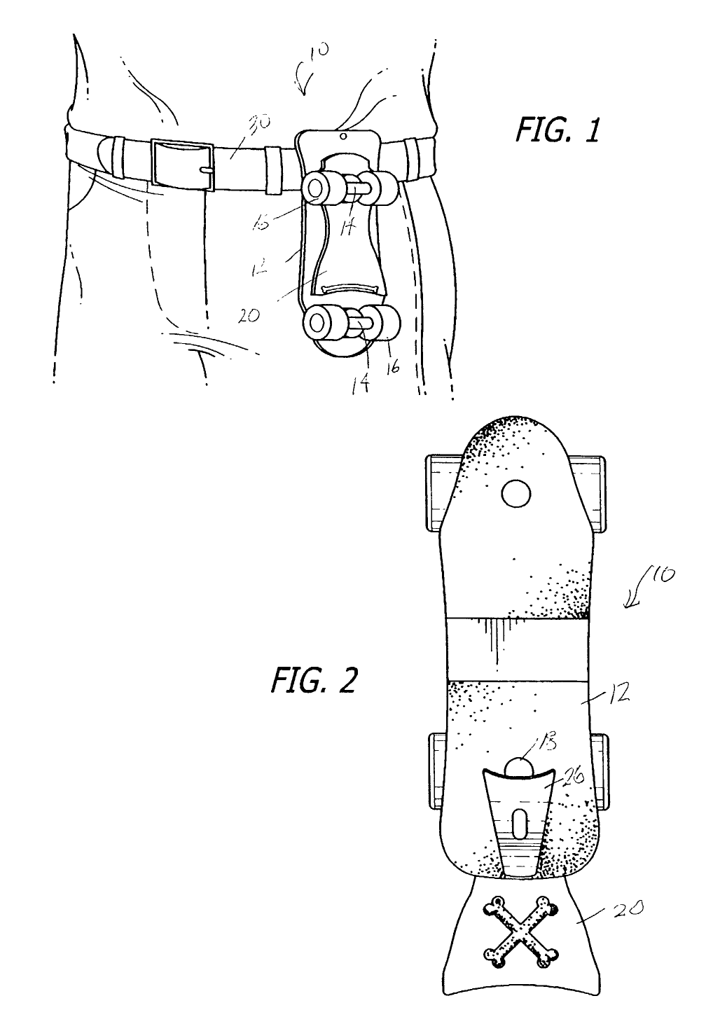

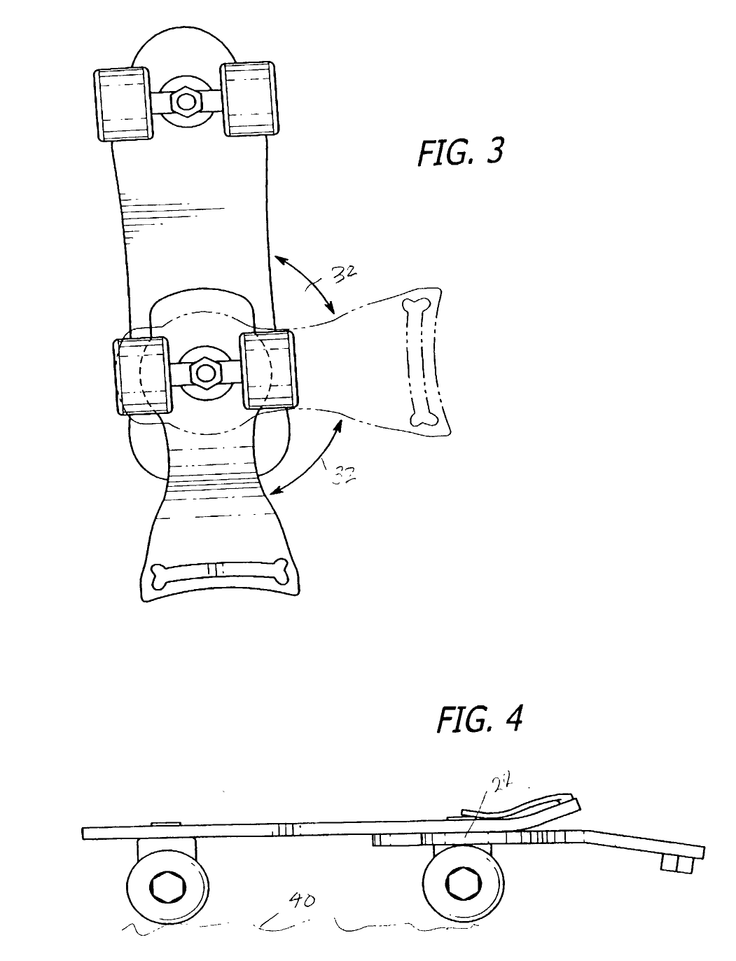

FIGS. 1-5 show a miniature skateboard which is generally indicated at 10 and which is disclosed and claimed in co-pending application ______ (attorney docket SPFUN-61140) and which is assigned of record to the assignee of record of this application.

The miniature skateboard 10 includes a platform 12. The platform 12 may be made from a suitable material such as wood or a plastic. The platform 12 may have dimensions less than those of a user's shoe. For example, the platform 12 may have a length of approximately six inches (6″) and a width of approximately two inches (2″). The platform 12 is sufficiently thick so that it supports the weight of the user when the user stands on the platform.

In the miniature skateboard disclosed and claimed in co-pending application _______ (attorney docket SPFUN-61140), a pair of axles 14 are switchably attached to the bottom surface of the platform 12 in a conventional manner at longitudinally spaced positions along the platform. A separate pair of wheels 16 are attached to each individual one of the axles 14 in a conventional manner. The wheels 16 on each axle 14 are laterally spaced from each other and adapted to be rotated in forward and rearward directions.

A pivot pin 18 extends through the platform at a position towards the rear of the platform in the miniature skateboard 10 disclosed and claimed in co-pending application ______ (attorney docket SPFUN-61140). A support member 20 has a hole 22 which extends through the pivot pin 18 to provide for a pivotable movement of the support member on the pivot pin as a fulcrum. The support member 20 may be made from a suitable material such as wood or a plastic.

The support member 20 is pivotable on the pivot pin 18 between a first position and a second position in the miniature skateboard 10 disclosed and claimed in co-pending application (attorney docket SPFUN-61140). In the first position, the support member 20 is disposed below the platform 12 as shown in FIG. 1. In the second position, support member 20 extends rearwardly from the platform 12 so that it can be considered to constitute an extension of the platform.

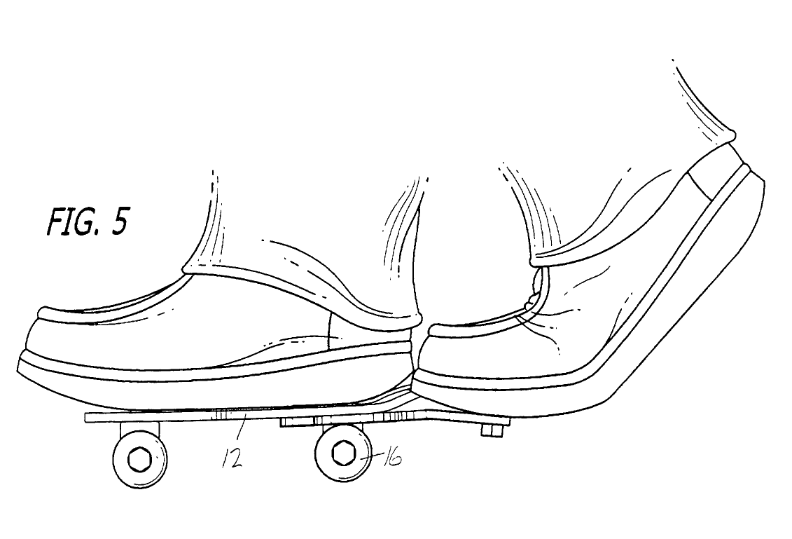

The dimensions of the support member 20 in the second (or extended position) in co-pending application ______ (attorney docket SPFUN-61140) provide for the disposition of the sole of one of the user's shoes on the support member 20 when the rear portion of the other of the user's shoes is disposed on the platform 12 (see FIG. 5). For example, the support member 20 may have a length of approximately two inches (2″) beyond the rear end of the platform in the second position of the support member and may have a width less than approximately two inches (2″) in the second position of the support member.

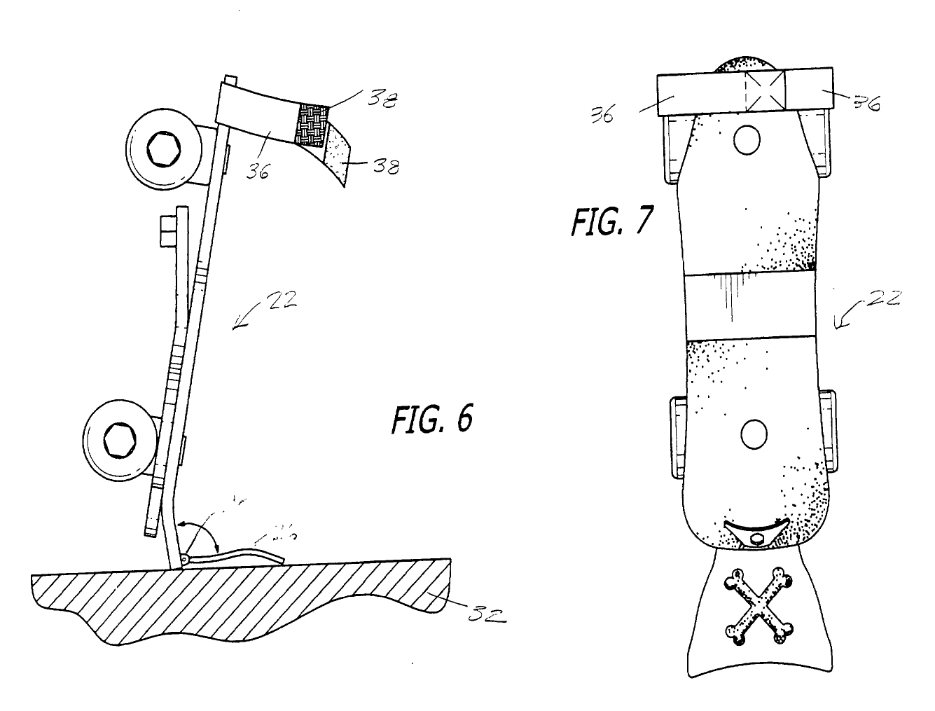

The miniature skateboard 10 described above and shown in FIGS. 1-5 is incorporated in a miniature skateboard generally indicated at 22 and constituting a preferred embodiment of this invention. The features patentably distinguishing the skateboard 22 from the skateboard 10 and from the prior art are particularly shown in FIGS. 6-8 and are described in detail hereafter.

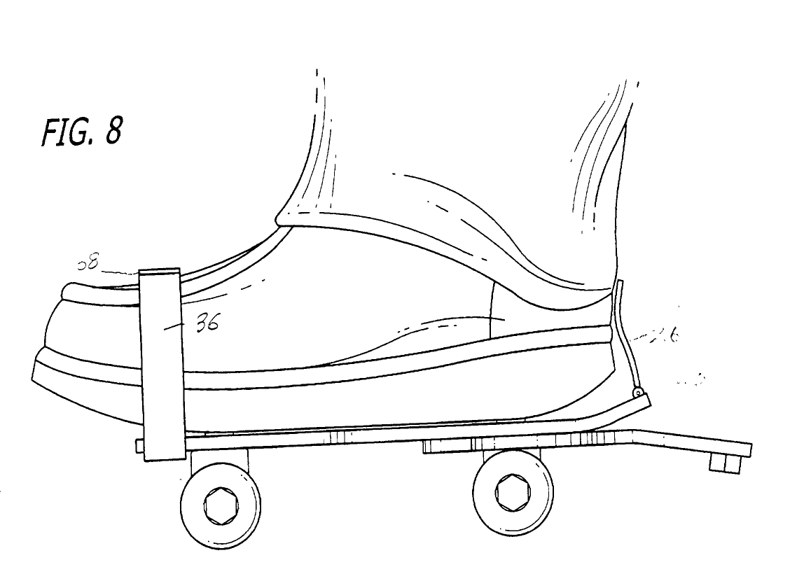

A clip 26 is disposed on the upper surface of the platform 12 at a position to the rear of the pivot pin 18 in the skateboard 22 constituting a preferred embodiment of this invention. The clip 26 is pivotally disposed on a retainer 28 which is disposed on the upper surface of the platform 12. In a first pivotal position, the clip 26 is constructed to retain the miniature skateboard 10 in coupled relationship to the user's belt strap 30 (FIG. 1) when the user is not operating the miniature skateboard. In a second pivotal position, the clip 26 serves as a back stop for the user's heel as shown schematically in FIG. 8. In the second position, the clip 26 also retains the skateboard 10 in an inclined relationship on a support surface 32 with the clip disposed on the support surface and the platform 12 pointing upwardly from the support surface as shown in FIG. 6.

When the user desires to operate the skateboard 10, the user pivots the support member 20 from the first position shown in FIG. 1 to the second position shown in FIG. 2. In this relationship of the skateboard 10, the user disposes the rear portion of one foot on the skateboard and moves the skateboard along the support surface 32 by pedaling with his second foot alternately on and off the support surface.

When the user has accelerated the skateboard 10 in this manner to a desired speed, the user may coast along the support surface 32 by disposing the sole of his second foot on the support member 20. When the user discontinues his operation of the skateboard 10, the user pivots the support member 20 to the position shown in FIG. 1. The user may then couple the clip 26 to his pants belt 30 or any portion of his clothing.

Since the platform 12 has a size less than that of the shoe of a user, the miniature skateboard 12 can be converted to a skate. This can be accomplished by providing a pair of straps 36 on the upper surface of the platform 12 at a position near the front of the platform and at opposite lateral ends of the platform by disposing a fastener 38 such as Velcro near the free ends of the straps. The straps 36 are then disposed tightly on the upper surfaces of the user's foot and bound tightly to each other as by the Velcro fasteners 38. This retains the bottom of the user's feet. The user's heel is retained by the clip 26 in the second position of the clip as shown schematically in FIG. 8.

Although this invention has been disclosed and illustrated with reference to particular embodiments, the systems involved are capable of being used in numerous other embodiments which will be apparent to persons of ordinary skill in the art. The invention is, therefore, to be limited only as indicated by the scope of the appended claims.

What is claimed is:

1. A miniature skateboard, including
a platform having a size preferably less than that of a user's shoe and having an upper surface for supporting the user when the user stands with one foot on the platform and having a lower surface,
a pair of axles spaced from each other in the longitudinal direction of the platform and supported on the lower surface of the platform,
a pair of wheels, each pair being disposed on an individual one of the axles and the wheels on each pair being spaced from each other in the lateral direction,
a support member coupled to the platform and movable relative to the platform between first and second positions, the support member being disposed in the first position under the platform and being operative in the second position to provide a support for the other one of the user's feet in back of the one foot on the platform, and
a clip disposed on the platform at a rearward position on the platform and movable relative to the platform between a first position providing for the attachment of the clip to the user's belt and a second position providing for the operation of the clip as a backstop for the user's heel and providing for the disposition of the miniature skateboard on a support surface in an upright position of the skateboard.

2. A miniature skateboard as set forth in claim 1 wherein
pivot pin is supported by the platform and wherein the support member is supported on the pin and is pivotable between the first and second positions.

3. A miniature skateboard as set forth in claim 1 wherein
the support member is manually pivotable by the user between the first and second positions.

4. A miniature skateboard as set forth in claim 1 wherein
the clip is manually pivotable relative to the platform between the first and second positions.

5. A miniature skateboard as set forth in claim 1 wherein
pivot pin is supported by the platform and wherein the support member is supported on the pin and is pivotable between the first and second positions and wherein
the support member is manually pivotable by the user between the first and second positions and wherein
the clip is manually pivotable between the first and second positions.

6. A miniature skateboard as set forth in claim 1 wherein
a pair of straps are disposed on the upper surface of the platform near the front end of the platform and near the opposite lateral ends of the platform and are attachable to each other in a removable relationship to convert the skateboard into a skate when the straps are removably attached to each other.

7. A miniature skateboard as set forth in claim 5 wherein
a pair of straps are disposed on the upper surface of the platform near the front end of the platform and near the opposite lateral ends of the platform and are attachable to each other in a removable relationship to convert the skateboard into a skate when the straps are removably attached to each other.

8. A miniature skateboard as set forth in claim 6 wherein
the clip is disposed at an angle relative to the platform to provide a support for the user's heel when the straps are attached to each other in an encompassing relationship to the bottom of the user's foot to convert the skateboard into a skate.

9. A miniature skateboard as set forth in claim 7 wherein
the clip is disposed at an angle relative to the platform to provide a support for the user's heel when the straps are attached to each other in an encompassing relationship to the bottom of the user's foot to convert the skateboard into a skate.

10. A miniature skateboard, including
a platform having upper and lower surfaces for receiving one of the user's feet on the upper surface of the platform the platform having a size preferably less than the size of one of the user's feet,
axle assemblies disposed on the bottom surface of the platform,
wheels attached to the axle assemblies for moving the platform,
a support member coupled to the platform and movable between a first position corresponding substantially to the position of the platform and a second position extending rearwardly from the platform to provide a support for the other one of the user's feet while the skateboard is moving without any acceleration provided by the user, and
a clip disposed on the platform at a position near the rear end of the platform and movable between a first position relative to the platform to provide for an attachment of the skateboard to the user and a second position providing for a of the skateboard in a tilted relationship to a support surface.

11. A miniature skateboard as set forth in claim 10 wherein
the support member is positioned in the second position relative to the platform to define a rearward extension of the platform for supporting the user's other foot.

12. A miniature skateboard as set forth in claim 10 wherein
the support member is pivotable relative to the platform between the first and second positions.

13. A miniature skateboard as set forth in claim 10 wherein
the support member is disposed under the platform in the first position of the support member and wherein the support member is shaped to support the user's other foot in the second position of the support member.

14. A miniature skateboard as set forth in claim 10 wherein
the clip is pivotable between the first and second positions.

15. A miniature skateboard as set forth in claim 10 wherein
the support member is pivotable relative to the platform between the first and second positions and wherein a pivot pin is provided on the platform at a position near the rear end of the platform to support the support member and provide for a manual pivoting of the support member between the first and second positions.

16. A miniature skateboard as set forth in claim 10 wherein
a retainer is disposed on the support member and wherein
the clip is pivotable on the retainer and is disposed in the second position to provide a support for the user's heel.

17. A miniature skateboard as set forth in claim 10 wherein
straps are disposed on the skateboard near the front of the skateboard and wherein
the straps are provided with fasteners at their free ends and wherein
the straps are disposed over the sole of the user's feet and are fastened to retain the user's sole on the platform.

18. A miniature skateboard as set forth in claim 17 wherein
a retainer is disposed on the support member and wherein
the clip is pivotable on the retainer and is disposed in the second position to provide a support for the user's heel and to cooperate with the fastening of the straps to convert the miniature skateboard to a skate.

19. A miniature skateboard as set forth in claim 10 wherein
the support member is positioned in the second position relative to the platform to define a rearward extension of the platform for supporting the user's other foot,
the support member is pivotable relative to the platform between the first and second positions, and
the clip is pivotable between the first and second positions.

20. A miniature skateboard as set forth in claim 10 wherein
the support member is disposed under the platform in the first position of the support member and wherein the support member is shaped to support the user's other foot in the second position of the support member and wherein
the support member is pivotable relative to the platform between the first and second positions and wherein a pivot pin is provided on the platform at a position near the rear end of the platform to support the support member and provide for a manual pivoting of the support member between the first and second positions and wherein
straps are disposed on the skateboard near the front of the skateboard and wherein
the straps are provided with fasteners at their free ends and wherein
the straps are disposed over the bottom of the user's foot and are fastened to each other to retain the user's foot on the platform.

21. A miniature skateboard as set forth in claim 19 wherein
the support member is disposed under the platform in the first position of the support member and wherein the support member is shaped to support the user's other foot in the second position of the support member and wherein
the support member is pivotable relative to the platform between the first and second positions and wherein a pivot pin is provided on the platform at a position near the rear end of the platform to support the support member and provide for a manual pivoting of the support member between the first and second positions and wherein
straps are disposed on the skateboard near the front of the skateboard and wherein
the straps are provided with fasteners at their free ends and wherein
the straps are disposed over the bottom of the user's foot and are fastened to retain the user's foot on the platform.
